(19) United States
(12) Patent Application Publication
(10) Pub. No.: US 2025/0262952 A1
(43) Pub. Date: Aug. 21, 2025

(54) CONTROL APPARATUS FOR VEHICLE

(71) Applicant: TOYOTA JIDOSHA KABUSHIKI KAISHA, Toyota-shi (JP)

(72) Inventor: Motoki TAKAHASHI, Susono-shi (JP)

(73) Assignee: TOYOTA JIDOSHA KABUSHIKI KAISHA, Toyota-shi (JP)

(21) Appl. No.: 19/053,235

(22) Filed: Feb. 13, 2025

(30) Foreign Application Priority Data
Feb. 20, 2024 (JP) 2024-024104

(51) Int. Cl. B60L 15/38

(52) U.S. Cl. CPC B60L 15/38; B60L 2200/28; B60L 2240/423

(57) ABSTRACT

A control apparatus including a processor configured to control a drive power of a towed vehicle which has a drive power source which is towed through a coupler by a towing vehicle. When the towing vehicle is running while towing the towed vehicle, the processor is configured to limit the drive power of the towed vehicle such that the towed vehicle does not push the towing vehicle through the coupler. Preferably, the processor is configured to calculate, based on a drive power of the towing vehicle, an upper limit value of an allowable range of the drive power of the towed vehicle in which the towed vehicle does not push the towing vehicle, and to limit the drive power of the towed vehicle by the upper limit value.

This application claims priority from Japanese Patent Application No. 2024-024104 filed on Feb. 20, 2024, the disclosure of which is herein incorporated by reference in its entirety.

### FIELD OF THE INVENTION

The present invention relates to a control apparatus for controlling a drive power of a towed vehicle.

### BACKGROUND OF THE INVENTION

There is well known a control apparatus that includes a drive control portion that controls a drive power of a towed vehicle which is towed by a towing vehicle through a coupler and which has a drive power source. For example, a control apparatus for an articulated vehicle described in Patent Document 1 is such a control apparatus. Patent Document 1 discloses a towing vehicle equipped with a first motor that can be driven by a first battery, and a towed vehicle equipped with a second motor that can be driven by a second battery.

### PRIOR ART DOCUMENT

### Patent Document

[Patent Document 1]
Japanese Patent Application Laid-Open No. 2013-184584

### SUMMARY OF THE INVENTION

A responsiveness of the drive power of the vehicle varies depending on the type or combination of the drive power sources, and varies among engine and electric vehicles. On the other hand, where the towed vehicle as well as the towing vehicle is adapted to generate the drive power, it is possible to increase an acceleration performance in a towing running state in which the towing vehicle runs the towed vehicle. However, if the responsiveness of the drive power varies among vehicles, a situation may occur in which the drive power of the towed vehicle is larger than necessary. Under such a situation, there is a concern that behavior of the towing vehicle may be disturbed or a driver of the towing vehicle may feel discomfort. If the drive power of the towed vehicle is greatly reduced, the above-described situation is unlikely to occur, but benefit of increasing the acceleration performance is unlikely to be obtained.

The present invention has been made in view of the above circumstances, and an object of the present invention is to provide a control apparatus capable of stabilizing behavior of a towing vehicle while enjoying an increase in acceleration performance by a drive power of a towed vehicle.

The present invention provides a control apparatus comprising a processor configured to control a drive power of a towed vehicle which has a drive power source which is towed through a coupler by a towing vehicle. When the towing vehicle is running while towing the towed vehicle, the processor is configured to limit the drive power of the towed vehicle such that the towed vehicle does not push the towing vehicle through the coupler.

In the control apparatus according to the present invention, when the towing vehicle is in the towing running state in which the towing vehicle is running while towing the towed vehicle, the drive power of the towed vehicle is limited such that the towed vehicle having the drive power source does not push the towing vehicle through the coupler. Thus, the towed vehicle generates the drive power, and thus, drive assistance in the towing running state can be performed. For example, improvement of acceleration performance and hill climbing performance, enlargement of towing capacity, extension of cruising distance and the like can be expected. Further, response of the drive power of the towed vehicle is controlled, and thus the towed vehicle is prevented or suppressed from pushing the towing vehicle. Therefore, it is possible to stabilize behavior of the towing vehicle while enjoying the improvement of the acceleration performance by the drive power of the towed vehicle.

### BRIEF DESCRIPTION OF THE DRAWINGS

FIG. 1 is a view showing a schematic configuration of a articulated vehicle to which the present invention is applied, and is a view showing control functions and main parts of a control system for various controls in the articulated vehicle.

FIGS. 2A and 2B are views showing an example of a towing running state in which a towing vehicle runs while towing a trailer as a towed vehicle.

FIG. 3 is a flowchart for explaining a main part of a control operation of a vehicle control apparatus, and is a flowchart for explaining a control operation for stabilizing behavior of the towing vehicle while enjoying an increase in acceleration performance by a drive power of the trailer.

FIG. 4 is a view showing an example of a time chart in a case where the control operation shown in the flowchart of FIG. 3 is executed.

FIG. 5 is a flowchart for explaining a main part of a control operation of the vehicle control apparatus, and is a flowchart for explaining a control operation for stabilizing behavior of the towing vehicle while enjoying an increase in acceleration performance by the drive power of the trailer, and is an embodiment different from FIG. 3.

FIG. 6 is a flowchart for explaining a main portion of a control operation of an electronic control device of the trailer, which is a flowchart for explaining a control operation for stabilizing behavior of the towing vehicle while enjoying an increase in acceleration performance by the drive power of the trailer, and is an embodiment different from FIGS. 3 and 5.

### DETAILED DESCRIPTION OF PREFERRED EMBODIMENTS

Hereinafter, embodiments of the present invention will be described in detail with reference to the drawings.

### First Embodiment

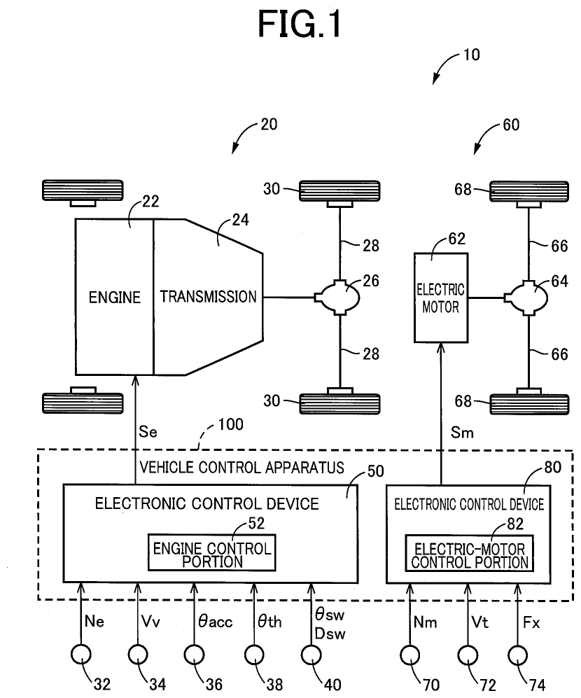

FIG. 1 is a view showing a schematic configuration of a articulated vehicle to which the present invention is applied, and is a view showing control functions and main parts of a control system for various controls in the articulated vehicle 10. In FIG. 1, the articulated vehicle 10 is a combination of a towing vehicle 20 and a trailer 60.

The towing vehicle 20 is, for example, a known automobile, and includes an engine 22, a transmission 24, a differential gear device 26, a drive shaft 28 and drive wheels 30. The engine 22 functions as a drive power source of the towing vehicle 20. An engine torque Te, which is a torque of the engine 22, is controlled by an electronic control device 50. In the towing vehicle 20, a power of the engine 22 is transmitted to the drive wheels 30 sequentially via the transmission 24, the differential gear device 26, the pair of drive shafts 28 and the like.

The trailer 60 is a towed vehicle towed by the towing vehicle 20. The trailer 60 includes an electric motor 62, a differential gear device 64, a drive shaft 66 and drive wheels 68. The electric motor 62 functions as a drive power source of the trailer 60. The electric motor 62 is controlled by an electronic control device 80, to generate an electric motor torque Tm. In the trailer 60, a power of the electric motor 62 is transmitted to the drive wheels 68 sequentially via the differential gear device 64, the pair of drive shafts 66 and the like. A regenerative torque, which is a negative torque of the electric motor torque Tm, may be transmitted to the drive wheels 68 as a braking torque.

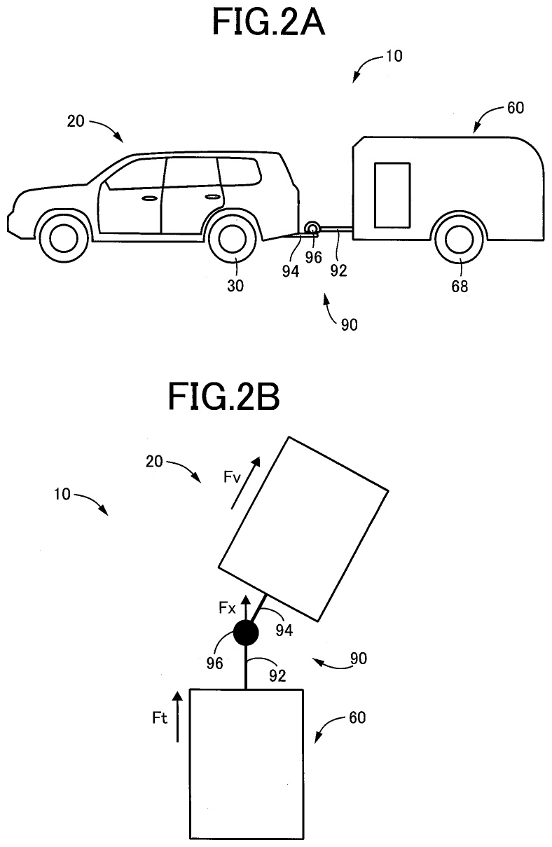

FIGS. 2A and 2B are views showing an example of a towing running state of the articulated vehicle 10 in which the towing vehicle 20 is running while towing the trailer 60. FIG. 2A is a side view as viewed from a left side of the articulated vehicle 10. FIG. 2B is a plan view as viewed from an upper side of articulated vehicle 10. In FIGS. 2A and 2B, the trailer 60 is towed by the towing vehicle 20 through a coupler 90. The coupler 90 includes, for example, a trailer hitch member 92 and a towing-vehicle hitch member 94. The trailer hitch member 92 is attached to a front end portion of the trailer 60. The towing-vehicle hitch member 94 is attached to a rear end portion of the towing vehicle 20. The trailer hitch member 92 and the towing-vehicle hitch member 94 are connected through a coupling portion 96. The coupling portion 96 is a coupling portion of the trailer 60 coupled to the towing vehicle 20, and is a distal end portion of the trailer hitch member 92 on a side of the towing vehicle 20. The coupling portion 96 corresponds to a coupling portion between the towing vehicle 20 and the trailer 60. The trailer 60 is towed by the towing vehicle 20 such that the coupler 90 prevents the towing vehicle 20 and the trailer 60 from approaching and separating from each other by the coupling portion 96 being coupled to the towing-vehicle hitch member 94.

Referring back to FIG. 1, the towing vehicle 20 further includes the electronic control device 50 as a controller related to controls of the engine 22 and the like. The electronic control device 50 includes a so-called microcomputer or processor including, for example, a CPU, a RAM, a ROM and an input/output interface. The CPU performs various controls of the towing vehicle 20 by performing signal processing according to a program stored in the ROM in advance while using a temporary storage function of the RAM, for example.

Various signals and the like based on values detected by various sensors and the like provided in the towing vehicle 20 are supplied to the electronic control device 50. The various sensors and the like provided in the towing vehicle 20 are, for example, an engine speed sensor 32, a vehicle running-speed sensor 34, an accelerator opening sensor 36, a throttle-valve opening sensor 38, a steering sensor 40 and the like. The various signals include, for example, an engine rotational speed Ne, a vehicle running speed Vv, an accelerator opening degree θacc, a throttle-valve opening degree θth, a steering angle θsw and a steering direction Dsw. The engine rotational speed Ne is a rotational speed of the engine 22. The vehicle running speed Vv is a running speed of the towing vehicle 20. The accelerator opening degree θacc is a signal corresponding to an acceleration request amount indicating a magnitude of an acceleration operation made by a driver of the towing vehicle 20, and is an accelerator operation amount by the driver. The throttle-valve opening degree θth is the opening degree of the electronic throttle valve. The steering angle θsw is a steering angle of a steering wheel of the towing vehicle 20. The steering direction Dsw is a steering direction of the steering wheel.

Various command signals and the like are outputted from the electronic control device 50 to various devices and the like provided in the towing vehicle 20. The various devices provided in the towing vehicle 20 include the engine 22, for example. The various command signals include an engine control command signal Se for controlling the engine 22, for example.

The trailer 60 further includes the electronic control device 80 as a controller related to control of the electric motor 62 and the like. The electronic control device 80 includes a so-called microcomputer or processor including, for example, a CPU, a RAM, a ROM and an input/output interface. The CPU executes various controls of the trailer 60 by performing signal processing in accordance with a program stored in the ROM in advance while using a temporary storage function of the RAM, for example.

Various signals and the like based on values detected by various sensors and the like provided in the trailer 60 are supplied to the electronic control device 80. The various sensors and the like provided in the trailer 60 are, for example, an electric-motor speed sensor 70, a vehicle running-speed sensor 72, a load sensor 74 and the like. The load sensor 74 is a sensor provided in the coupler 90, particularly, in the coupling portion 96 (see FIGS. 2A and 2B), and is, for example, a strain gauge. The various signals include an electric-motor rotational speed Nm, a trailer running speed Vt and a hitch load Fx. The electric-motor rotational speed Nm is a rotational speed of the electric motor 62. The trailer running speed Vt is a running speed of the trailer 60. The hitch load Fx is a load applied to the coupler 90, particularly, to the coupling portion 96, and corresponds to a difference between a vehicle drive power Fv and a trailer drive power Ft in consideration of, for example, the steering angle θsw, a weight of the towing vehicle 20, a weight of the trailer 60 and the like (see FIGS. 2A and 2B). The vehicle drive power Fv is a drive power of the towing vehicle 20. The trailer drive power Ft is a drive power of the trailer 60. The hitch load Fx corresponds to a magnitude obtained by subtracting the vehicle drive power Fv from the trailer drive power Ft. When the hitch load Fx is a positive value (Fx>0), a direction of the hitch load Fx is a direction in which the trailer 60 pushes the towing vehicle 20. When the hitch load Fx is a negative value (Fx<0), the trailer 60 does not push the towing vehicle 20, that is, the towing vehicle 20 pulls the trailer 60.

Various command signals and the like are outputted from the electronic control device 80 to various devices and the like provided in the trailer 60. The various devices provided in the trailer 60 include the electric motor 62, for example. The various command signals include a motor control command signal Sm for controlling the electric motor 62, for example.

The electronic control device 50 and the electronic control device 80 are connected to each other in a wired or wireless manner so as to be able to communicate with each other. The electronic control device 50 and the electronic control device 80 cooperate with each other to constitute a vehicle control apparatus 100 that performs a drive control, for example.

The electronic control device 50 includes an engine control portion 52 that controls the engine 22 in order to realize various controls in the towing vehicle 20. The engine control portion 52 calculates a requested vehicle drive amount Qvdem, which is a requested drive amount for the towing vehicles 20, by applying the accelerator operation amount θacc and the vehicle running speed Vv to a requested vehicle drive amount map MAPv, for example. The requested vehicle drive amount map MAPv is a relationship for obtaining the requested vehicle drive amount Qvdem, which is obtained and stored in advance, for example, experimentally or by design, that is, which is determined in advance. The requested vehicle drive amount Qvdem is, for example, the vehicle drive power Fv requested for the towing vehicle 20, that is, a requested vehicle drive power Fvdem in the drive wheels 30. The engine control portion 52 calculates a requested engine torque Tedem that is a requested value of the engine torque Te for realizing the requested vehicle drive amount Qvdem, in consideration of, for example, a transmission loss, an auxiliary load, a gear ratio of the transmission 24 and the like. The engine control portion 52 outputs an engine control command signal Se for controlling the engine 22 so as to obtain the requested engine torque Tedem.

The electronic control device 80 includes an electric-motor control portion 82 that controls the electric motor 62 in order to realize various controls in the trailer 60. The electric-motor control portion 82 calculates a trailer drive request amount Qtdem, which is a drive request amount for the trailer 60, by applying the accelerator opening degree θacc and the trailer running speed Vt to a requested trailer drive amount map MAPt, for example. The requested trailer drive amount map MAPt is a relationship for obtaining a predetermined trailer drive request amount Qtdem, for example. The trailer drive request amount Qtdem is, for example, a trailer drive power Ft requested for the trailer 60, that is, a requested trailer drive power Ftdem in the drive wheel 68. The motor control portion 82 calculates a requested motor torque Tmdem, which is a requested value of the motor torque Tm for realizing the trailer drive request amount Qtdem, in consideration of, for example, a transmission loss. The electric-motor control portion 82 outputs an electric-motor control command signal Sm for controlling the electric motor 62 so as to obtain the requested motor torque Tmdem. In this way, the electric-motor control portion 82 functions as a drive control portion that controls the trailer drive power Ft.

By the way, in consideration of output characteristics of the engine 22 and the electric motor 62, a responsiveness of the vehicle drive power Fv to the requested vehicle drive power Fvdem may be inferior to a responsiveness of the trailer drive power Ft to the requested trailer drive power Ftdem. Therefore, during acceleration such as when the accelerator is turned on or when the accelerator is increased, the trailer drive power Ft temporarily becomes larger than the vehicle drive power Fv, and there is a possibility that the trailer 60 would push the towing vehicle 20 at one point from the connection portion 96 through the coupler 90. In this case, there is a concern that behavior of the towing vehicle 20 could be disturbed. Unless otherwise specified, the vehicle drive power Fv is synonymous with an actual vehicle drive power Fvr which is an actual value of the vehicle drive power Fv, and the trailer drive power Ft is synonymous with an actual trailer drive power Ftr which is an actual value of the trailer drive power Ft.

Therefore, the electric-motor control portion 82 controls the response of the trailer drive power Ft in order to avoid the trailer 60 from pushing the towing vehicle 20 through the coupler 90. For example, the electric-motor control portion 82 limits the trailer drive power Ft such that the trailer 60 does not push the towing vehicle through the coupler 90 when the towing vehicle 20 is in the towing running state in which the towing vehicle 20 is running while towing the trailer 60 through the coupler 90.

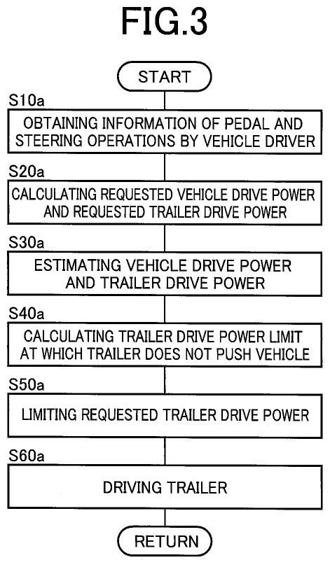

FIG. 3 is a flowchart showing a main part of the control operation of the vehicle control apparatus 100, and is a flowchart showing a control routine for stabilizing the behavior of the towing vehicle 20 while enjoying the improvement of the acceleration performance by the trailer drive power Ft. This control routine is repeatedly executed, for example.

In FIG. 3, first, at step S10a corresponding to function of the electronic control device 50, information such as the accelerator opening degree θacc, the steering angle θsw and the steering direction Dsw is obtained. Next, at step S20a corresponding to functions of the engine control portion 52 and the motor control portion 82, the requested vehicle drive power Fvdem and the requested trailer drive power Ftdem are calculated. Next, at step S30a corresponding to functions of the engine control portion 52 and the motor control portion 82, an estimated value of the vehicle drive power Fv and an estimated value of the trailer drive power Ft are calculated. For example, the estimated value of the vehicle drive power Fv is calculated by a predetermined approximate expression in which a response delay with respect to the requested vehicle drive power Fvdem is taken into consideration. Alternatively, the estimated value of the vehicle drive power Fv is calculated based on the actual engine torque Te. In this instance, the steering angle θsw, the steering direction Dsw, the braking power by wheel brakes and the like may be considered. Further, for example, the estimated value of the trailer drive power Ft is calculated by a predetermined approximate expression in which a response delay with respect to the requested trailer drive power Ftdem is taken into consideration. Alternatively, the estimated value of the trailer drive power Ft is calculated based on the actual electric motor torque Tm. Next, at step S40a corresponding to function of the motor control portion 82, a trailer drive power limit Ftlim, which is an upper limit value of the trailer drive power Ft at which the trailer 60 does not push the towing vehicle 20 through the coupler 90, is calculated based on the estimated value of the vehicle drive power Fv. For example, the trailer drive power limit Ftlim, which is an upper limit value of an allowable range of the trailer drive power Ft in which the hitch load Fx becomes a negative value in calculation, is calculated based on the estimated value of the trailer drive power Fv. Next, at step S50a corresponding to function of the motor control portion 82, the requested trailer drive power Ftdem is limited or upper-guarded to the trailer drive power limit Ftlim. That is, when the requested trailer drive power Ftdem exceeds the trailer drive power limit Ftlim, the requested trailer drive power Ftdem is set to the trailer drive power limit Ftlim. Next, at step S60a corresponding to function of the electric-motor control portion 82, the electric motor 62 is controlled using the requested trailer drive power Ftdem whose upper limit is guarded by the trailer drive power limit Ftlim, and the trailer 60 is driven. That is, the requested trailer drive power Ftdem, whose upper limit is guarded by the trailer drive power limit Ftlim, is reflected in the trailer drive power Ft.

In this way, the electric-motor control portion 82 calculates the trailer drive power limit Ftlim, which is the upper limit of the allowable range of the trailer drive power Ft in which the trailer 60 does not push the towing vehicle 20, based on the vehicle drive power Fv, and then limits the trailer drive power Ft by the trailer drive power limit Ftlim. The trailer drive power limit Ftlim is the upper limit of the allowable range of the trailer drive power Ft in which the hitch load Fx is less than a load value by which the towing vehicle 20 is pushed by the trailer 60, namely, in which the hitch load Fx does not act in a direction by which the towing vehicle 20 is pushed by the trailer 60. That is, the trailer drive power limit Ftlim is determined such that the trailer 60 does not push the towing vehicle 20.

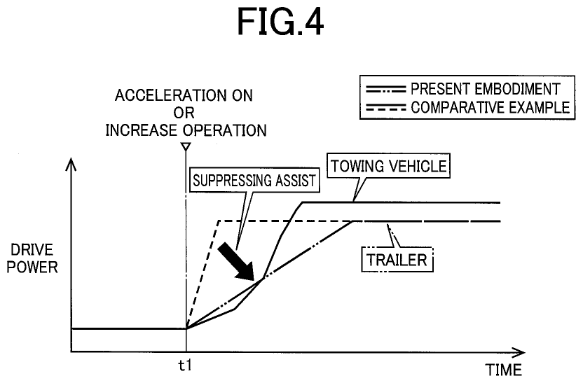

FIG. 4 is a view showing an example of a time chart in a case where the control routine shown in the flowchart of FIG. 3 is executed. FIG. 4 shows an example of the case of starting or accelerating. In FIG. 4, a time point t1 indicates a time point at which the accelerator is turned on or a time point at which the accelerator is operated to increase the acceleration. In a comparative example indicated by a broken line, the trailer drive power Ft is generated with better responsiveness than the vehicle drive power Fv. In such a situation, the trailer 60 pushes the towing vehicle 20. In contrast, in the present embodiment indicated by two dot chain line, the trailer drive power Ft is limited by the trailer drive power limit Ftlim, and thus a situation in which the trailer 60 pushes the towing vehicle 20 is avoided or suppressed.

As described above, according to the present embodiment, the trailer 60 includes the electric motor 62 as the drive power source. Accordingly, the trailer 60 generates the trailer drive power Ft, and thus, drive assistance can be performed in the towing running state in which the towing vehicle 20 is running while towing the trailer 60, and for example, improvement of acceleration performance or hill climbing performance, increase of towing capacity and extension of running distance can be expected. In addition, when the towing vehicle 20 is in the towing running state, the trailer drive power Ft is limited such that the trailer 60 does not push the towing vehicle through the coupler 90. Accordingly, the response of the trailer drive power Ft is controlled, and thus the trailer 60 is prevented or suppressed from pushing the towing vehicle 20. Therefore, it is possible to stabilize the behavior of the towing vehicle 20 while enjoying the improvement of the acceleration performance by the trailer drive power Ft.

Further, according to the present embodiment, the trailer drive power limit Ftlim is calculated based on the vehicle drive power Fv, and the trailer drive power Ft is limited by the trailer drive power limit Ftlim. The trailer drive power limit Ftlim is the upper limit of the allowable range of the trailer drive power Ft in which the hitch load Fx is less than a load value by which the towing vehicle 20 is pushed by the towed vehicle 60, namely, in which the hitch load Fx does not act in a direction by which the towing vehicle 20 is pushed by the trailer 60. Thus, the trailer drive power Ft is appropriately limited such that the trailer 60 does not push the towing vehicle 20 in the towing running state.

Next, other embodiments of the present invention will be described. In the following description, the same reference numerals are given to the same parts as those in the first embodiment, and the description thereof will be omitted.

### Second Embodiment

In the first embodiment, the trailer drive power Ft is limited by calculating the trailer drive power limit Ftlim. In this embodiment, the trailer drive power Ft is limited by the direction of the hitch load Fx.

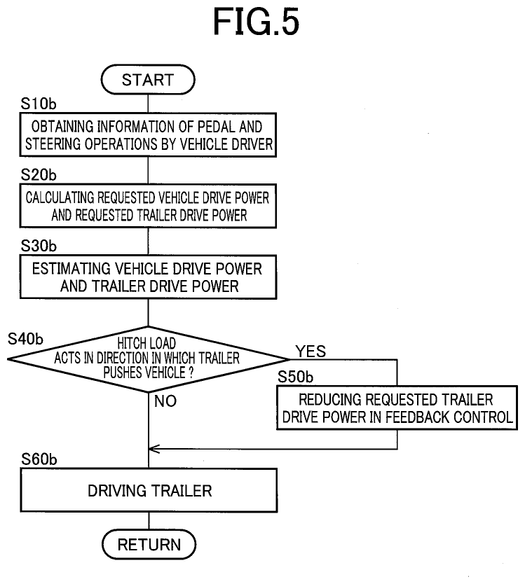

FIG. 5 is a flowchart showing a main part of the control operation of the vehicle control device 100, and is a flowchart showing a control routine for stabilizing the behavior of the towing vehicle 20 while enjoying the improvement of the acceleration performance by the trailer drive power Ft, and is repeatedly executed, for example. The flow chart of FIG. 5 shows the control routine, which is executed in this second embodiment and which is different from the control routine shown in the flowchart of FIG. 3.

In FIG. 5, steps S10b, S20b and S30b are the same as steps S10a, S20a and S30a in FIG. 3, and therefore, the description thereof is omitted. Step S30b is followed by step S40b corresponding to function of the electric-motor control portion 82, which is implemented to calculate the hitch load Fx by using the steering angle θsw, the steering direction Dsw, the estimated value of the vehicle drive power Fv, the estimated value of the trailer drive power Ft and the like, and to obtain the direction of the hitch load Fx. Then, it is determined whether or not the direction of the hitch load Fx corresponds to a direction in which the trailer 60 pushes the towing vehicle 20. At this step S40b, a detection signal of the load sensor 74 indicative of the hitch load Fx may be used. When an affirmative determination is made at this step S40b, the requested trailer drive power Ftdem is subtracted or reduced at S50b corresponding to function of the electric-motor control portion 82. For example, the requested trailer drive power Ftdem is reduced in a feedback control such that the hitch load Fx is less than a load value by which the towing vehicle 20 is pushed by the trailer 60, namely, in which the hitch load Fx does not act in a direction by which the towing vehicle 20 is pushed by the trailer 60. Alternatively, the requested trailer drive power Ftdem is subtracted or reduced depending on the hitch load Fx such that the requested trailer drive power Ftdem is reduced by a magnitude that is increased as the hitch load Fx is increased. When a negative determination is made at this step S40b, or after implementation of step S50b, step S60b corresponding to function of the motor control portion 82 is implemented to control the motor 62 by using the requested trailer drive power Ftdem, and to drive the trailer 60. Further, at step S60b, the requested trailer drive power Ftdem calculated at step S20b is used as it is, and is reflected in the trailer drive power Ft. When an affirmative determination is made at step S40b, the requested trailer drive power Ftdem reduced at step S50b is used and is reflected in the trailer drive power Ft.

In this way, the electric motor control portion 82 obtains the direction of the hitch load Fx and limits the trailer drive power Ft such that the direction of the hitch load Fx becomes a direction in which the trailer 60 does not push the towing vehicle 20.

As described above, according to the present second embodiment, similarly to the first embodiment described above, it is possible to achieve the behavior stabilization of the towing vehicle 20 while enjoying the improvement of the acceleration performance by the trailer drive power Ft.

Further, according to the present second embodiment, the direction of the hitch load Fx is obtained, and the trailer drive power Ft is limited such that the direction of the hitch load Fx becomes a direction in which the trailer 60 does not push the towing vehicle 20. Thus, the trailer drive power Ft is appropriately limited such that the trailer 60 does not push the towing vehicle 20 in the towing running state.

### Third Embodiment

In the first and second embodiments, the electronic control device 50 and the electronic control device 80 cooperate with each other to constitute the vehicle control device 100 that performs the drive control of the articulated vehicle 10. In the present third embodiment, the electronic control device 80 limits the trailer drive power Ft independently without cooperating with the electronic control device 50. Therefore, in the present third embodiment, the trailer drive power Ft is limited by using the hitch load Fx which is the signal supplied from the load sensor 74.

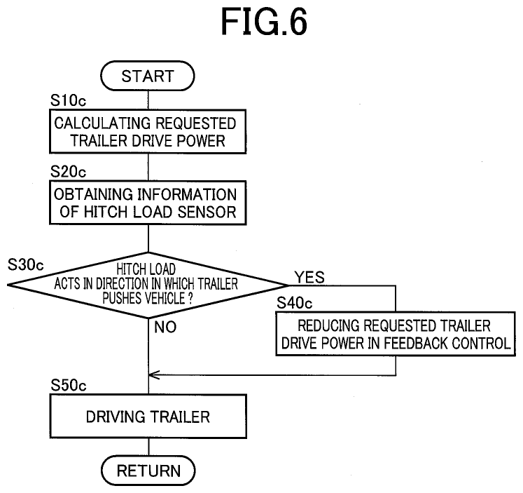

FIG. 6 is a flowchart showing a main part of the control operation of the electronic control device 80, and is a flowchart showing a control routine for stabilizing the behavior of the towing vehicle 20 while enjoying the improvement of the acceleration performance by the trailer drive power Ft, and is repeatedly executed, for example. The flow chart of FIG. 6 shows the control routine, which is executed in this third embodiment and which is different from the control routines shown in the flowcharts of FIGS. 3 and 5. The control routine shown in the flow chart of FIG. 6 can be completed only by the electronic control device 80.

In FIG. 6, each step of the control routine corresponds to function of the electric motor control portion 82. At step S10c, the requested trailer drive power Ftdem is calculated. At this step S10c, the accelerator opening θacc is not used, and the requested trailer drive power Ftdem for resisting a running resistance of the trailer 60 is calculated based on the trailer running speed Vt, for example. Next, at step S20c, information of the hitch load Fx which is the signal supplied from the load sensor 74 is obtained. Next, at step S30c, it is determined whether or not the direction of the hitch load Fx is a direction in which the trailer 60 pushes the towing vehicle 20. When an affirmative determination is made at step S30c, step S40c is implemented. Since this step S40c is the same as step S50b in FIG. 5, and therefore, the description thereof is omitted. When a negative determination is made at step S30c, or after implementation of step S40c, step S50c is implemented to control the electric motor 62 by using the requested trailer drive power Ftdem, and to drive the trailer 60. Further, when the negative determination is made at step S30c, the requested trailer drive power Ftdem calculated at step S10c is used as it is, and is reflected in the trailer drive power Ft. When an affirmative determination is made at step S30c, the requested trailer drive power Ftdem reduced at step S40c is used and reflected in the trailer drive power Ft.

In this way, the electric-motor control portion 82 obtains the magnitude and the direction of the hitch load Fx by the load sensor 74, and limits the trailer drive power Ft when the direction of the hitch load Fx is the direction in which the trailer 60 pushes the towing vehicle 20. When limiting the trailer drive power Ft, the electric motor control portion 82 increases the magnitude of reduction in the trailer drive power Ft as the magnitude of the hitch load Fx is increased.

As described above, according to the present third embodiment, similarly to the first and second embodiments described above, it is possible to achieve the behavior stabilization of the towing vehicle 20 while enjoying the improvement of the acceleration performance by the trailer drive power Ft.

According to the present third embodiment, the magnitude and the direction of the hitch load Fx are obtained by the load sensor 74, and the trailer drive power Ft is limited when the direction of the hitch load Fx is the direction in which the trailer 60 pushes the towing vehicle 20. When the trailer drive power Ft is limited, the magnitude of reduction in the trailer drive power Ft is increased as the magnitude of the hitch load Fx is increased. Thus, the trailer drive power Ft is appropriately limited such that the trailer 60 does not push the towing vehicle 20 in the towing running state. Further, the trailer drive power Ft can be limited by the trailer 60 alone such that the trailer 60 does not push the towing vehicle 20.

Although the embodiments of the present invention have been described in detail with reference to the drawings, the present invention is also applicable to other aspects.

For example, in the first to third embodiments described above, the strain gauge is used as an example of the load sensor 74, but the present invention is not limited to the detail. For example, the sensor provided in the coupling portion 96 may be a sensor capable of detecting the magnitude and the direction of the hitch load Fx, and may be a load cell, a displacement sensor or the like that are different from the strain gauge. The displacement sensor calculates the magnitude and the direction of the hitch load Fx by a displacement amount, for example. In the first and second embodiments described above, the trailer drive power Ft can be limited without using the hitch load Fx which is the detection signal of the load sensor 74, and thus the load sensor 74 may not be provided.

In the first to third embodiments, for example, an electric motor may be used as the power source of the towing vehicle 20 instead of or in addition to the engine 22. The transmission 24 is, for example, a known planetary gear type automatic transmission, a known belt type continuously variable transmission, a known synchronous meshing type parallel two shaft automatic transmission, a known electric continuously variable transmission, a known synchronous meshing type parallel two shaft manual transmission or the like. In a case where the power source included in the towing vehicle 20 is an electric motor, the towing vehicle 20 may not include the transmission 24.

In the first to third embodiments, when the articulated vehicle 10 turns, an assist power from the trailer 60 is applied in a direction slightly deviated from a longitudinal direction of the towing vehicle 20, and thus the assist power may act in an unintended direction (see FIG. 2B). Therefore, the present invention is particularly useful when the articulated vehicle 10 turns.

In the third embodiment, a way (degree) of being pulled in the towing running state may be estimated based on the trailer speed Vt with respect to the trailer drive power Ft, and the magnitude and the direction of the hitch load Fx may be estimated by the way of being pulled. In this case, the load sensor 74 may not be provided.

In the third embodiment, since the trailer 60 can limit the trailer drive power Ft by itself, the vehicle control apparatus 100 may include at least the electronic control device 80. Further, the electronic control device 50 and the electronic control device 80 may not be connected to each other for communication with each other.

The above description is merely one embodiment, and the present invention can be implemented in a mode in which various modifications and improvements are added based on the knowledge of those skilled in the art.

### NOMENCLATURE OF ELEMENTS

20: towing vehicle
50: electronic control device
60: trailer (towed vehicle)
62: electric motor (drive power source)
74: load sensor (sensor)
80: electronic control device
82: electric-motor control portion (drive control portion)
90: coupler
100: vehicle control apparatus (control apparatus)

What is claimed is:

1. A control apparatus comprising a processor configured to control a drive power of a towed vehicle which has a drive power source which is towed through a coupler by a towing vehicle,
wherein, when the towing vehicle is running while towing the towed vehicle, the processor is configured to limit the drive power of the towed vehicle such that the towed vehicle does not push the towing vehicle through the coupler.

2. The control apparatus according to claim 1,
wherein the processor is configured to calculate, based on a drive power of the towing vehicle, an upper limit value of an allowable range of the drive power of the towed vehicle in which the towed vehicle does not push the towing vehicle, and to limit the drive power of the towed vehicle by the upper limit value.

3. The control apparatus according to claim 2,
wherein the allowable range of the drive power of the towed vehicle is a range in which a load applied to the coupler is less than a load value by which the towing vehicle is pushed by the towed vehicle.

4. The control apparatus according to claim 1,
wherein the processor is configured to obtain a direction of a load applied to the coupler, and to limit the drive power of the towed vehicle such that the direction of the load becomes a direction in which the towed vehicle does not push the towing vehicle.

5. The control apparatus according to claim 1,
wherein the processor is configured to obtain a magnitude and a direction of a load applied to the coupler, by a sensor provided in the coupler, and
wherein the processor is configured, when the direction of the load is a direction in which the towed vehicle pushes the towing vehicle, to limit the drive power of the towed vehicle, and to reduce the drive power of the towed vehicle by a magnitude that is increased as the magnitude of the load applied to the coupler is increased.
